(19) United States
(12) Patent Application Publication
(10) Pub. No.: US 2025/0114756 A1
(43) Pub. Date: Apr. 10, 2025

(54) DECANTER AND AERATOR

(71) Applicant: Design Bunker, Inc., Seattle, WA (US)

(72) Inventors: Madeleine BUSCH, Driftwood, TX (US); Joshua STEWART, Edmonds, WA (US)

(21) Appl. No.: 18/887,530

(22) Filed: Sep. 17, 2024

Related U.S. Application Data
(60) Provisional application No. 63/588,564, filed on Oct. 6, 2023.

(51) Int. Cl. B01F 25/421; A47G 23/02; B01F 23/232; B01F 23/237; B01F 101/17

(52) U.S. Cl. CPC B01F 25/4231; A47G 23/0241; B01F 23/232; B01F 23/237611; B01F 2101/17

(57) ABSTRACT

A combination wine decanter and aerator system includes a base with an integrated and removable coaster. The decanter is received on the base to assist with stabilizing the decanter. The decanter includes an opening that removably receives the aerator. The aerator includes a deflector plate and an aerator body that cooperate to define at least a two-stage tortuous flow path through the aerator and into the decanter. The decanter may include a raised bottom surface that adds a third stage to the tortuous flow path and further aerates wine in the decanter. The aerator can be removed from the decanter and received on the removable coaster when not in use.

### BACKGROUND

### Technical Field

The present disclosure is generally directed to a decanter and an associated aerator that may be particularly beneficial for aeration of wine.

### Description of the Related Art

Wine decanters are generally known and typically include a vessel with an opening at the top. A bottle of wine is poured into the vessel through the opening. Exposure of the wine to air in the vessel aerates the wine, while storing the wine in the vessel allows sediment to separate and settle at the bottom of the vessel. Known wine decanters have a number of deficiencies and drawbacks, including that wine should be decanted for at least 30 minutes, if not longer, for desirable aeration and separation of sediment. As such, wine decanters are not a practical solution in situations where users do not wish to wait for the aeration of the wine in a decanter.

In response, wine aerators have been developed that aim to aerate wine much more quickly. However, known wine aerators are often attached to a bottle and are not associated with a decanter as a complete solution. Such bottle-mounted aerators are also difficult to pour and result in leaks or drips during use. Many prior wine aerator designs are also overly complex, resulting in a prohibitively high cost. In addition, many aerators leak or drip after they are removed from the bottle, which is a particular challenge when wine drips and stains fabrics or other materials and surfaces.

As a result, it would be beneficial to have a decanter and aerator that overcome the above deficiencies and drawbacks of known devices.

### BRIEF SUMMARY

The present disclosure is generally directed to a decanter and aerator that can be used together in combination to aerate wine, or which can also be used separately as desired. The aerator is removably securable into an opening of the decanter to allow a user to pour wine through the aerator and into the decanter for storage and further aeration in the decanter. The aerator can be removed to enable more effective pouring of the wine from the decanter rather than through the aerator. The aerator includes a funnel, deflector plate, and an aerator body. The deflector plate and aerator body preferably have surfaces with a high surface area in contact with the wine, such as curved surfaces or other shapes described herein, that provide at least a two-step tortuous path for the flow of wine through the aerator and into the decanter. The decanter has a raised bottom surface that spreads the incoming stream of aerated wine from the aerator that acts as a third, final aeration step before the wine settles into the wine decanter. The decanter sits on a base that includes a removable coaster. Once the wine is poured through the aerator and into the decanter, the aerator can be removed from the decanter and placed on the coaster to avoid drips onto a surface.

Additional features and advantages of the concepts of the disclosure are provided in more detail below with reference to the accompanying drawings.

### BRIEF DESCRIPTION OF THE SEVERAL VIEWS OF THE DRAWINGS

The present disclosure will be more fully understood by reference to the following figures, which are for illustrative purposes only. These non-limiting and non-exhaustive implementations are described with reference to the following drawings, wherein like labels refer to like parts throughout the various views unless otherwise specified. The figures do not describe every aspect of the teachings disclosed herein and do not limit the scope of the claims.

FIG. 1 is an isometric view of an implementation of a combination decanter and aerator system according to the present disclosure.

FIG. 2 is an exploded view of a base and a removable coaster of the system of FIG. 1.

FIG. 3A is a cross-sectional view of the aerator of the system of FIG. 1 along line A-A in FIG. 1.

FIG. 3B is a cross-sectional view of the aerator of the system of FIG. 1 along line B-B in FIG. 2.

FIG. 4 is a cross-sectional view of the aerator and the decanter of the system of FIG. 1 along line A-A in FIG. 1.

### DETAILED DESCRIPTION

Persons of ordinary skill in the relevant art will understand that the present disclosure is illustrative only and not in any way limiting. Other implementations of the presently disclosed systems and methods readily suggest themselves to such skilled persons having the assistance of this disclosure.

Each of the features and teachings disclosed herein can be utilized separately or in conjunction with other features and teachings to provide wine decanter and aerator devices, systems, and methods. Representative examples utilizing many of these additional features and teachings, both separately and in combination, are described in further detail with reference to the attached Figures. This detailed description is merely intended to teach a person of skill in the art further details for practicing aspects of the present teachings and is not intended to limit the scope of the claims. Therefore, combinations of features disclosed in the detailed description may not be necessary to practice the teachings in the broadest sense and are instead taught merely to describe particularly representative examples of the present teachings.

Moreover, the various features of the representative examples and the dependent claims may be combined in ways that are not specifically and explicitly enumerated to provide additional useful implementations of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help understand how the present teachings are practiced but are not intended to limit the dimensions and the shapes shown in the examples in some implementations. In some implementations, the dimensions and the shapes of the components shown in the figures are exactly to scale and intended to limit the dimensions and the shapes of the components.

The present disclosure is generally directed to a combination wine decanter and aerator system. While the present disclosure will proceed to describe certain non-limiting examples of the combination system, it is to be understood that individual components or subsystems of the system may be used and sold separately from the other parts in additional applications. For example, the wine aerator may be marketed and sold as a separate product from the combination system, as could the wine decanter and/or the base. A separate wine aerator may have features that are adapted for different use cases, such as with a wine glass or others, and not solely for use with a decanter. It is also noted that the concepts of the disclosure can be applied outside the wine aeration context, such as for other fluid flow applications. Thus, the present disclosure is not limited to the combination system for the aeration of wine described herein but contemplates additional uses and modifications of the constituent parts in a wider variety of applications.

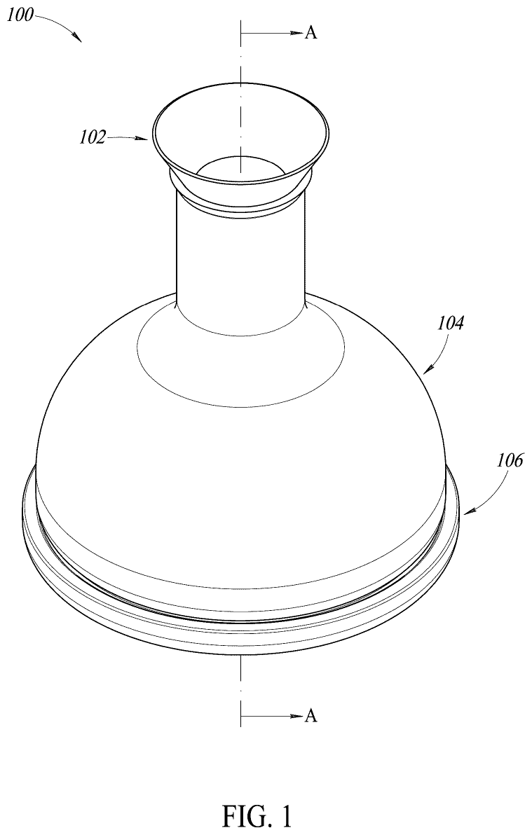

FIG. 1 is an isometric view of an implementation of a combination decanter and aerator system 100 according to the present disclosure. The combination system 100 includes an aerator 102, a decanter 104, and a base 106 removably coupled together. The aerator 102 is removably securable to an opening in the decanter 104 and the decanter 104 is removably securable to the base 106. In operation, the base 106 may be placed on a support surface, such as a table, bar, or others, to provide a flat support surface for the decanter 104. The decanter 104 is placed on the base 106 and the aerator 102 is selectively placed in the opening of the decanter 104.

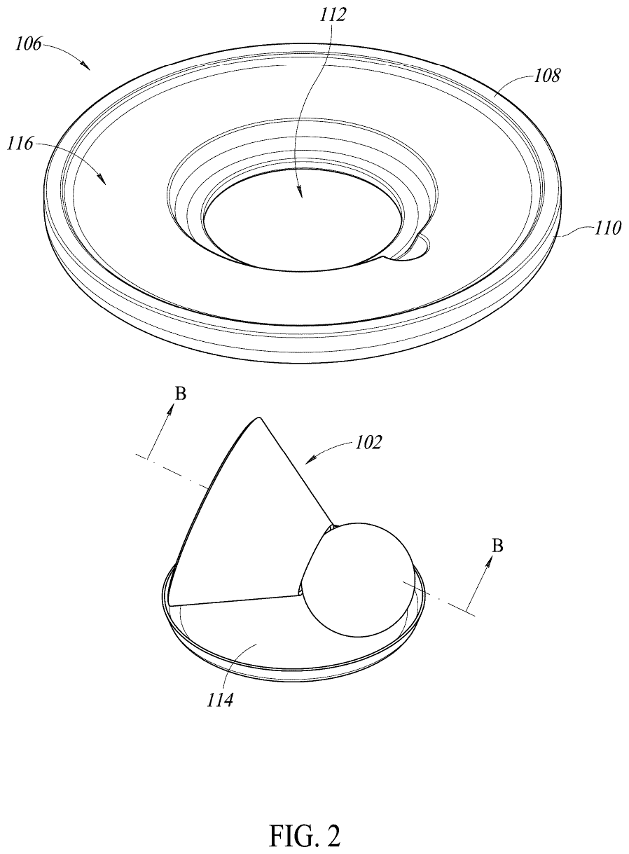

FIG. 2 is an exploded view of the base 106 of the system 100. The base 106 includes an outer lip or ridge 108 extending around at least a portion of, or all of, an outer edge 110 of the base 106. The lip 108 has a size and a shape to receive and secure the decanter 106 inside the lip 108 relative to the base 106 to prevent lateral movement of the decanter 104 on the base 106 and increase stability of the decanter 104 when the decanter 104 is seated on the base 106. The base 106 further includes an aperture 112 that may be centrally located relative to the base 106. The aperture 112 removably receives a coaster 114. In operation, the coaster 114 can be unseated from the cavity 112 in the base 106 and placed on a support surface to provide a storage location for the aerator 102 after pouring wine that avoids wine drips and spills from the aerator 102, as shown in FIG. 2. After use, the coaster 114 can be removably secured to the base 106 and stored in the aperture 112 in an integral or nested combination. When the coaster 114 is received in the aperture 112, the coaster 114 may be flat and planar with a major flat surface 116 of the base 106 to avoid extending beyond the major flat surface 116 and destabilizing the decanter 104 when the decanter 104 is seated on the base 106. In some implementations, the aperture 112 may extend only partially or all the way through the base 106. The aperture 112 may also be located at a selected location on the base 106 other than centered relative to the base as in FIG. 2. Further, the base 106 may omit the aperture 112 and coaster 114 in some implementations and may instead be a solid, continuous piece of material. The aperture 112 and coaster 114 may also have a selected size and shape that may be different than that shown in the drawings.

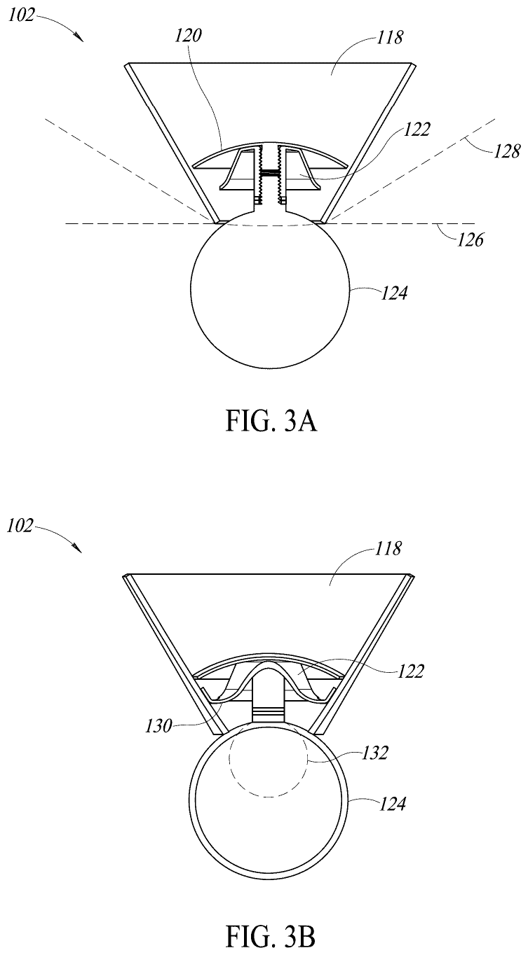

FIG. 3A and FIG. 3B are cross-sectional views of the aerator 102. FIG. 3A is a cross-sectional view taken along line A-A through a center of the aerator 102 in FIG. 1. The remaining parts of the system 100 are omitted in FIG. 3A to avoid obscuring features of the aerator 102. FIG. 3B is an off-center cross-sectional taken along line B-B in FIG. 2 illustrating additional features of the aerator 102 again with the remaining parts of the system 100 omitted.

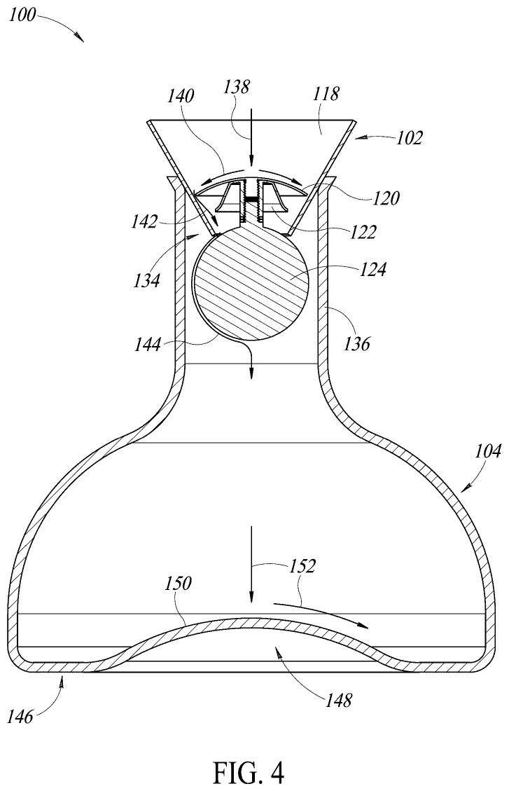

Beginning with FIG. 3A, the aerator 102 includes a funnel 118, a deflector plate 120, a support plate 122, and an aerator body 124. The funnel 118 may be a truncated cone open at both ends that includes sloping sidewalls to define a fluid passageway between the open ends of the funnel 118. In an implementation, the opening at the top of the funnel 118 is larger than the opening at the bottom of the funnel 118 according to the orientation in FIG. 3A such that the funnel 118 directs fluid flow into and toward a center of the aerator 102 and decanter 104. The deflector plate 120 is positioned in the fluid passageway defined by the funnel 118 (i.e., internal to or within the funnel 118) and will be described further with reference to FIG. 4. The support plate 122 assists with coupling the deflector plate 120 to the aerator body 124, as shown in FIG. 3A. In an implementation, both the deflector plate 120 and the aerator body 124 have threads that engage counter threads and openings in the support plate 122. As described further with reference to FIG. 3B, the support plate 122 is coupled to the funnel 118 and further assists with spacing the deflector plate 120 from sidewalls of the funnel 118 while also securing the deflector plate 120 and the aerator body 124 to each other. Further, the support plate 122 assists with positioning the deflector plate 120 and the aerator body 124 relative to the funnel 118, which defines the size of the gaps or spaces between the funnel 118 and the deflector plate 120 and the aerator body 124, which in turn, controls the flow rate through the aerator 102.

In an implementation, the size and shape of the funnel 118 is selected based on the intended application for the aerator 102. For example, where the aerator 102 is intended for use with a relatively narrow opening, such as of the decanter 104, the sidewalls of the funnel 118 may be positioned at an angle to horizontal 126 above 45 degrees and less than 90 degrees and more preferably, greater than 60 degrees and less than 90 degrees including all intervening values. Such a sidewall angle is indicated with the solid lines of the funnel 118 in FIG. 3A. In some applications, it is preferable to implement the funnel 118 with wider and shallower sidewalls, as generally indicated with dashed lines 128. Such shallower and wider sidewalls may be particularly beneficial for wider openings, such as for a wine glass, among others. In some implementations, the sidewalls of the funnel 118 represented by dashed lines 128 may be at an angle to horizontal 126 that is less than 45 degrees and greater than 0 degrees including all intervening values. In sum, the arrangement and angle of the sidewalls of the funnel 118 may be selected to fit different size openings including for decanters and wine glasses, among other vessels.

Turning to FIG. 3B, illustrated therein is the coupling between the support plate 122 and the funnel 118. The support plate 122 may include a selected number of arms 130 that extend from the support plate 122 and are coupled to the sidewalls of the funnel 118. The arms 130 are preferably spaced from each other about the support plate 122 to allow liquid to flow through the gaps or spaces between the arms 130. In an implementation, the support plate 122 includes three arms 130 spaced equidistant about the support plate 122, although other configurations are contemplated, including two, four, five or more arms 130 with a selected spacing relative to each other. FIG. 3B also includes dashed lines 132 that are provided to indicate that the shape and size of the aerator body 124 may generally be selected. While the aerator body 124 is a hollow or solid sphere with a smooth outer surface in a preferred implementation such that wine flows in a thin, uninterrupted layer around an outer surface of the body 124, many other configurations of the aerator body 124 are contemplated herein. For example, the aerator body 124 may be a cylinder, a cone, a cube, a prism with a selected number of sides, a cuboid, a pyramid with a selected number of sides, a diamond, a prism with a selected number of sides, a polyhedron with a selected number of sides, a torus, an ellipsoid, or any combination thereof. In general, the aerator body 124 can be any three-dimensional shape with a selected number of faces, edges, and vertices.

In addition, the aerator body 124 may be solid steel or stone, or hollow and filled with freezer gel or another phase change or energy storage material that enables the aerator body 124 to be used as a chilling feature. In such implementations, the aerator 102 (or at least the aerator body 124) may be placed in a freezer such that the aerator body 124 chills wine as it flows around the body 124. Still further, where the body 124 at least partially touches wine a vessel, such as in a wine glass, the aerator 124 may provide such chilling functionality by direct contact with wine the vessel downstream of the aerator 102.

Further, a size of the aerator body 124 can generally be selected. For example, the aerator body 124 may be larger in applications where the aerator 102 is used with a decanter 104 or may be smaller where the aerator 102 is used with a shallower vessel, such as a wine glass. Accordingly, the present disclosure is not limited by the size and shape of the aerator body 102. Other configurations for the aerator body 124 are contemplated herein beyond changes in shape, such as an aerator body 124 where liquid flows through the body 124 and out of holes, openings, or spouts of the body 124 into the decanter 104. Still further, the body 124 may have a ridge, lip, or protrusion on its outer surface or may be a flat or sloped disk similar to the deflector plate 120 to vary the flow path of the wine around and/or through the aerator body 124 and more generally, through the aerator 102. Many other configurations are possible and are contemplated herein.

FIG. 4 is a cross-sectional view of the aerator 102 and decanter 104 of the system 100 to illustrate operation of these aspects of the system 100. The base 106 is omitted to avoid repetitive description. In operation, a user places the aerator 102 into an opening 134 in a neck 136 of the decanter 104 with the aerator body 124 arranged downward and extending into the decanter 104 and the funnel 118 extending upward out of the decanter 104. The funnel 118 of the aerator 102 engages the neck 136 (i.e., sidewalls of the decanter 104 at the opening 136) with the sloped side walls of the funnel 118 holding the aerator 102 in place relative to the aerator 104. The weight of the aerator body 124 may also assist with securing the aerator 102 to the decanter 104. A user pours wine into the funnel 118, as indicated by arrow 138, with the funnel 118 assisting with guiding the wine into the aerator 102. The wine contacts the deflector plate 120 and spreads into a thin layer across the deflector plate 120 towards sidewalls of the funnel 118. In other words, the deflector plate 120 thins and spreads the incoming wine across the relatively large surface area of the deflector plate 120 and pushes it outwards towards the sidewalls of the funnel 118 (i.e., away from a center of the deflector plate 120) as a result of the shape and slope of the deflector plate 120, as shown by arrows 140. The deflector plate 120 may also reduce splashing of the wine. The wine then traverses through a gap between an outer edge of the deflector plate 120 and the funnel 118 and through the spaces between the arms 130 of the support plate 122 (see FIG. 3B), as indicated by arrow 142.

The deflector plate 120 is preferably spaced from the funnel 118 around an entire circumference of the deflector plate 120, although the same is not required and the deflector plate 120 could be attached to the funnel 118 with openings, slots, or other like arrangements for allowing fluid flow. A size of the gap between the outer edge of the deflector plate 120 and the funnel 118 can be varied to vary fluid flow rate through the aerator 102. While the deflector plate 120 preferably has a shape similar to a partial section of a sphere (or a curved, partially circular shape), other shapes and sizes of plates are contemplated for the deflector plate 120, including any of the shapes discussed herein as well as partial sections of such shapes discussed herein. After passing the deflector plate 120 and the openings between the arms of the support plate 122, the wine is directed by the funnel 118 back toward a center of the aerator 102 and converges at the bottom of the funnel 118 and the top of the aerator body 124. In an implementation, at least a portion of the aerator body 124 extends into the lower opening of the funnel 118 to assist with collecting wine or fluid from the funnel 118 and dispersing the same around the aerator body 124. The wine from the funnel 118 is then thinly dispersed over the surface area of the aerator body 124 and travels in a thin layer around an outside surface of the aerator body 124 before coalescing at the bottom of the aerator body 124, as indicated by arrow 144. Thus, the aerator 102 can be summarized as providing at least a two-stage tortuous flow path for aeration of wine that includes the deflector plate 120 (first stage) and the aerator body 124 (second stage). At both stages, the wine is spread into a thin layer to maximize a surface area of the wine in contact with air to maximize the aeration efficiency of the aerator 102. At the same time, the flow around the deflector plate 122 and the aerator body 124, including the changes of direction of the fluid at these locations, induce turbulent flow that maximizes interaction with air, thereby improving aeration.

Once the wine reaches the bottom of the aerator body 124, the wine forms a stream that travels downward into the decanter 104. The decanter 104 has an outer bottom surface 146 with a concavity 148 that forms a semi-circular or partially spherical protrusion 150, step, or raised inner bottom surface inside the decanter 104. Other shapes for the protrusion 150 are contemplated herein, including any of the shapes discussed herein as well partial sections of such shapes. The stream of wine from the aerator body 124 hits the protrusion 150 in the bottom of the decanter 104 with the wine again spreading into a thin layer for further aeration, as shown by arrows 152. The protrusion 150 acts a third aeration step in the overall tortuous flow path of the wine through the combination aerator and decanter 100. The wine then collects along the lower elevation sides of the bottom of the decanter 104. The user can remove the aerator 102 and place the aerator 102 on the coaster 114 to avoid drips or spills from the aerator 102 after use, as described and shown with reference to FIG. 2. Removal of the aerator 102 allows wine to be more effectively poured out of the opening 134 in the neck 136 of the decanter 104. It is also noted that the system 100 is suitable for use with other fluids beyond wine should decanting of such fluids be desired.

As a result, the concepts of the disclosure provide for rapid aeration of wine that is an improvement over known decanters. At the same time, the aerator is removable to allow for more effective pouring of wine via the decanter with the aerator generally having an effective design that minimizes costs. The disclosure also overcomes the issue of drips or leaks from an aerator after removing the aerator from the pouring location (i.e., bottle or decanter) by providing an integrated coaster on which the aerator can be placed when not in use. In some implementations, the deflector plate and/or support plate may further include or more holes to assist with draining wine out of the aerator before the aerator is removed from the decanter. The base of the combination system helps stabilize the decanter and prevent spills while also providing integral and nested storage for the coaster when the coaster is not in use.

In one or more implementations, a system may be summarized as including: a base; a decanter removably received on the base and including an opening; and an aerator removably received in the opening of the decanter, wherein the aerator and decanter cooperate to define at least a three-stage tortuous flow path through the aerator and into the decanter.

In an implementation, the base includes an integral and removable coaster.

In an implementation, the aerator includes a funnel and a deflector plate positioned within a fluid path through the funnel.

In an implementation, the aerator includes an aerator body downstream of the funnel, wherein the deflector plate and the aerator body cooperate to define at least a two-stage tortuous flow path through the aerator and into the decanter.

In an implementation, the deflector plate is configured to spread and distribute a fluid away from a center of the funnel toward a gap between an outer edge of the deflector plate and the funnel to form an initially aerated fluid stream.

In an implementation, the aerator body is configured to spread and distribute the initially aerated fluid stream around an outside surface of the aerator body to form a further aerated fluid stream.

In an implementation, the decanter includes a raised bottom surface configured to spread and distribute the further aerated fluid stream and form a finally aerated fluid stream.

In one or more implementations, a system may be summarized as including: a base; a decanter removably received on the base; and an aerator removably associated with the decanter, wherein the aerator includes a funnel, a deflector plate positioned within the funnel, and an aerator body downstream of the funnel, wherein the deflector plate and the aerator body cooperate to define at least a two-stage tortuous flow path through the aerator and into the decanter.

In an implementation, the aerator body is a sphere positioned below an outlet of the funnel.

In an implementation, the deflector plate is configured to spread and distribute a fluid away from a center of the funnel toward a gap between an outer edge of the deflector plate and the funnel and form an initially aerated fluid stream.

In an implementation, the aerator body is configured to spread and distribute the initially aerated fluid stream around an outside surface of the aerator body to form a further aerated fluid stream.

In an implementation, the aerator further includes a support plate, the support plate having arms coupled to the funnel.

In an implementation, the deflector plate and the aerator body are coupled to the support plate.

In an implementation, the arms of the support plate are spaced from each other to enable fluid flow through the spaces between the arms.

In one or more implementations, a system may be summarized as including:

an aerator including a funnel, a deflector plate positioned in a fluid path through the funnel, and an aerator body downstream of the funnel, wherein the deflector plate and the aerator body cooperate to define at least a two-stage tortuous flow path through the aerator.

In an implementation, the system may further include a base with an integrated and removable coaster, the coaster configured to receive the aerator.

In an implementation, the system may further include a decanter configured to be received on the base, the decanter including an opening configured to interface with the aerator.

In an implementation, the deflector plate is a curved plate configured to direct fluid away from a center of the funnel toward an outer edge of the funnel.

In an implementation, the aerator body is positioned proximate an outlet of the funnel.

In an implementation, the aerator further includes a support plate coupled to the funnel, wherein the support plate is positioned between the deflector plate and the aerator body.

The above description of illustrated implementations, including what is described in the Abstract, is not intended to be exhaustive or to limit the implementations to the precise forms disclosed. Although specific implementations and examples are described herein for illustrative purposes, various equivalent modifications can be made without departing from the spirit and scope of the disclosure, as will be recognized by those skilled in the relevant art. The teachings provided herein of the various implementations can be applied outside of the wine decanter and aerator context, and are not limited to the example systems, methods, and devices generally described above.

Many of the methods described herein can be performed with variations. For example, many of the methods may include additional acts, omit some acts, and/or perform acts in a different order than as illustrated or described.

In the above description, certain specific details are set forth in order to provide a thorough understanding of various implementations of the disclosure. However, one skilled in the art will understand that the disclosure may be practiced without these specific details. In other instances, well-known structures associated with induction heating devices, systems, and methods have not been described in detail to avoid unnecessarily obscuring the descriptions of the implementations of the present disclosure.

Certain words and phrases used in the specification are set forth as follows. As used throughout this document, including the claims, the singular form “a”, “an”, and “the” include plural references unless indicated otherwise. Any of the features and elements described herein may be singular, e.g., a shell may refer to one shell. The terms “include” and “comprise,” as well as derivatives thereof, mean inclusion without limitation. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Other definitions of certain words and phrases are provided throughout this disclosure.

The use of ordinals such as first, second, third, etc., does not necessarily imply a ranked sense of order, but rather may only distinguish between multiple instances of an act or a similar structure or material.

Throughout the specification, claims, and drawings, the following terms take the meaning explicitly associated herein, unless the context clearly dictates otherwise. The term “herein” refers to the specification, claims, and drawings associated with the current application. The phrases “in one implementation,” “in another implementation,” “in various implementations,” “in some implementations,” “in other implementations,” and other derivatives thereof refer to one or more features, structures, functions, limitations, or characteristics of the present disclosure, and are not limited to the same or different implementations unless the context clearly dictates otherwise. As used herein, the term “or” is an inclusive “or” operator, and is equivalent to the phrases “A or B, or both” or “A or B or C, or any combination thereof,” and lists with additional elements are similarly treated.

Generally, unless otherwise indicated, the materials for making the invention and/or its components may be selected from appropriate materials such as composite materials, ceramics, plastics, metal, polymers, thermoplastics, elastomers, plastic compounds, glass, wood, and the like, cither alone or in any combination.

The foregoing description, for purposes of explanation, uses specific nomenclature and formula to provide a thorough understanding of the disclosed implementations. It should be apparent to those of skill in the art that the specific details are not required in order to practice the invention. The implementations have been chosen and described to best explain the principles of the disclosed implementations and its practical application, thereby enabling others of skill in the art to utilize the disclosed implementations, and various implementations with various modifications as are suited to the particular use contemplated. Thus, the foregoing disclosure is not intended to be exhaustive or to limit the invention to the precise forms disclosed, and those of skill in the art recognize that many modifications and variations are possible in view of the above teachings.

The terms “top,” “bottom,” “upper,” “lower,” “up,” “down,” “above,” “below,” “left,” “right,” and other like derivatives take their common meaning as directions or positional indicators, such as, for example, gravity pulls objects down and left refers to a direction that is to the west when facing north in a Cardinal direction scheme. These terms are not limiting with respect to the possible orientations explicitly disclosed, implicitly disclosed, or inherently disclosed in the present disclosure and unless the context clearly dictates otherwise, any of the aspects of the implementations of the disclosure can be arranged in any orientation.

As used herein, the term “substantially” is construed to include an ordinary error range or manufacturing tolerance due to slight differences and variations in manufacturing. Unless the context clearly dictates otherwise, relative terms such as “approximately,” “substantially,” and other derivatives, when used to describe a value, amount, quantity, or dimension, generally refer to a value, amount, quantity, or dimension that is within plus or minus 5% of the stated value, amount, quantity, or dimension. It is to be further understood that any specific dimensions of components or features provided herein are for illustrative purposes only with reference to the various implementations described herein, and as such, it is expressly contemplated in the present disclosure to include dimensions that are more or less than the dimensions stated, unless the context clearly dictates otherwise.

The present application claims priority to U.S. Provisional Patent Application No. 63/588,564 filed on Oct. 6, 2023, the entire contents of which are incorporated herein by reference.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the breadth and scope of a disclosed implementation should not be limited by any of the above-described implementations, but should be defined only in accordance with the following claims and their equivalents.

1. A system, comprising:
a base;
a decanter removably received on the base and including an opening; and
an aerator removably received in the opening of the decanter, wherein the aerator and decanter cooperate to define at least a three-stage tortuous fluid path through the aerator and into the decanter.

2. The system of claim 1, wherein the base includes an integral and removable coaster.

3. The system of claim 1, wherein the aerator includes a funnel and a deflector plate positioned within a fluid path through the funnel.

4. The system of claim 3, wherein the aerator includes an aerator body downstream of the funnel, wherein the deflector plate and the aerator body cooperate to define at least a two-stage tortuous flow path through the aerator and into the decanter.

5. The system of claim 3, wherein the deflector plate is configured to spread and distribute a fluid away from a center of the funnel toward a gap between an outer edge of the deflector plate and the funnel to form an initially aerated fluid stream.

6. The system of claim 5, wherein the aerator body is configured to spread and distribute the initially aerated fluid stream around an outside surface of the aerator body to form a further aerated fluid stream.

7. The system of claim 6, wherein the decanter includes a raised bottom surface configured to spread and distribute the further aerated fluid stream and form a finally aerated fluid stream.

8. A system, comprising:
a base;
a decanter removably received on the base; and
an aerator removably associated with the decanter, wherein the aerator includes:
a funnel;
a deflector plate positioned within the funnel; and
an aerator body downstream of the funnel, wherein the deflector plate and the aerator body cooperate to define at least a two-stage tortuous flow path through the aerator and into the decanter.

9. The system of claim 8, wherein the aerator body is a sphere positioned below an outlet of the funnel.

10. The system of claim 8, wherein the deflector plate is configured to spread and distribute a fluid away from a center of the funnel toward a gap between an outer edge of the deflector plate and the funnel and form an initially aerated fluid stream.

11. The system of claim 10, wherein the aerator body is configured to spread and distribute the initially aerated fluid stream around an outside surface of the aerator body to form a further aerated fluid stream.

12. The system of claim 8, wherein the aerator further includes a support plate, the support plate having arms coupled to the funnel.

13. The system of claim 12, wherein the deflector plate and the aerator body are coupled to the support plate.

14. The system of claim 12, wherein the arms of the support plate are spaced from each other to enable fluid flow through the spaces between the arms.

15. A system, comprising:
an aerator, including:
a funnel;
a deflector plate positioned in a fluid path through the funnel; and
an aerator body downstream of the funnel, wherein the deflector plate and the aerator body cooperate to define at least a two-stage tortuous flow path through the aerator.

16. The system of claim 15, further comprising:
a base with an integrated and removable coaster, the coaster configured to receive the aerator.

17. The system of claim 16, further comprising:
a decanter configured to be received on the base, the decanter including an opening configured to interface with the aerator.

18. The system of claim 15, wherein the deflector plate is a curved plate configured to direct fluid away from a center of the funnel toward an outer edge of the funnel.

19. The system of claim 15, wherein the aerator body is positioned proximate an outlet of the funnel.

20. The system of claim 15, wherein the aerator further includes a support plate coupled to the funnel, wherein the support plate is positioned between the deflector plate and the aerator body.
